(19) United States
(12) Patent Application Publication
(10) Pub. No.: US 2026/0105079 A1
(43) Pub. Date: Apr. 16, 2026

(54) KNOWLEDGE GRAPH-ENHANCED RETRIEVAL-AUGMENTED GENERATION WITH MULTI-AGENT SYSTEM

(71) Applicant: MasterControl Solutions, Inc., Salt Lake City, UT (US)

(72) Inventors: Bhavik AGARWAL, Philadelphia, PA (US); Hemant Sunil JOMRAJ, Boston, MA (US); Simone KAPLUNOV, Menlo Park, CA (US); Jack KROLIK, Palo Alto, CA (US); Viktoria ROJKOVA, San Antonio, TX (US)

(21) Appl. No.: 19/355,798

(22) Filed: Oct. 10, 2025

Related U.S. Application Data
(60) Provisional application No. 63/707,644, filed on Oct. 15, 2024.
(60) Provisional application No. 63/794,197, filed on Apr. 24, 2025.

(51) Int. Cl. G06F 16/3329; G06F 16/338; G06F 16/358; G06F 18/213; G06F 18/22; G06N 3/0475

(52) U.S. Cl. CPC G06F 16/3329; G06F 16/338; G06F 16/358; G06F 18/213; G06F 18/22; G06N 3/0475

(57) ABSTRACT

A system is configurable to: (i) process a document corpus to generate a plurality of relational unit sets, wherein each relational unit set of the plurality of relational unit sets is based on a respective set of text from the document corpus; (ii) process the plurality of relational unit sets to generate a set of relational unit set embeddings; and (iii) construct a vector index comprising a plurality of vectors, wherein each vector of the plurality of vectors includes elements comprising: (a) a respective relational unit set from the plurality of relational unit sets; (b) an indication of the respective set of text from the document corpus on which the respective relational unit set is based; and (c) the relational unit set embedding generated by processing the respective relational unit set.

### CROSS-REFERENCE TO RELATED APPLICATIONS

This application claims priority to (i) U.S. Provisional Application Ser. No. 63/707,644, filed on Oct. 15, 2024, and entitled “KNOWLEDGE GRAPH-ENHANCED RAG WITH MULTI-AGENT SYSTEM” and (ii) U.S. Provisional Application Ser. No. 63/794,197, filed on Apr. 24, 2025, and entitled “KNOWLEDGE GRAPH-ENHANCED RAG WITH MULTI-AGENT SYSTEM”; the entirety of each of the foregoing applications is incorporated herein by reference for all purposes.

### BACKGROUND

Question answering (QA) refers to the field of computing concerned with enabling systems to receive natural language queries and return relevant information in response. QA systems are used across a variety of domains to facilitate access to information contained in large information sources (e.g., databases). These systems aim to interpret the intent of a user's question and identify content that is responsive to that intent. The field of QA has seen increasing adoption in both general-purpose and domain-specific applications. As the volume and complexity of digital information continue to grow, QA systems play an increasingly important role in helping users efficiently locate and understand relevant content.

The subject matter claimed herein is not limited to embodiments that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIGS. 1 and 2 illustrate example flow diagrams depicting various operations, components, data objects, and/or other aspects associated with the disclosed subject matter.

FIGS. 3 and 4 illustrate conceptual representations of user interfaces associated with the disclosed subject matter.

FIG. 5 illustrates a conceptual representation of graphing of triplets.

FIG. 6 depicts example components of a system that may comprise or implement one or more aspects of the disclosed subject matter.

### DETAILED DESCRIPTION

Disclosed embodiments are directed to systems, methods, and techniques related to knowledge graph-enhanced retrieval-augmented generation.

As noted above, QA systems are used across a variety of domains to facilitate access to information contained in large information sources. While such systems have demonstrated utility in general-purpose applications, they often exhibit limitations that become more pronounced in specialized or high-stakes domains. One common issue is the generation of inaccurate or imprecise responses, which may result from incomplete understanding of the query, insufficient contextual awareness, or reliance on heuristics that fail to capture domain-specific nuances.

In some cases, QA systems may produce responses that appear plausible but are not grounded in the underlying data (a phenomenon commonly referred to as hallucination). Hallucinated outputs can undermine user trust and pose significant risks when the QA system is deployed in environments where factual correctness is paramount. For example, in regulatory compliance contexts, responses should not only be accurate but also traceable to authoritative sources. A failure to meet these standards may lead to misinterpretation of legal obligations, noncompliance with governing regulations, or adverse outcomes in audit or enforcement scenarios.

Existing QA frameworks may also struggle to maintain consistency across related queries, particularly when the underlying information is distributed across multiple documents or expressed in complex, interrelated formats. This can result in fragmented or contradictory answers, further complicating the user's ability to make informed decisions. Moreover, some QA systems utilize on predefined ontologies or rigid schemas that may not adapt well to evolving regulatory landscapes or heterogeneous data sources, limiting their applicability in dynamic domains.

As described herein, in some implementations, a corpus of domain-relevant documents may be processed to construct a knowledge representation for facilitating question answering. Rather than utilizing a predefined ontology or rigid schema, the system may extract relational units (e.g., subject-predicate-object triplets) directly from the corpus itself. These relational units may be used to construct an ontology-free knowledge graph that reflects the relationships expressed in the source material.

The knowledge graph may be updated incrementally as the corpus evolves, allowing the system to remain aligned with current information without manual schema revisions. Each relational unit may be linked to the corresponding portion of the source text from which it was derived, preserving provenance and enabling traceability.

The knowledge graph (e.g., the relational unit sets thereof) may be embedded into a vector space to support retrieval-augmented generation. In some implementations, user queries may be projected into the same embedding space and compared against the embedded relational unit sets to identify relevant portions of the graph (e.g., relevant subject-predicate-object triplets) and associated source text. These materials may then be used to generate a response to the query.

The use of an ontology-free knowledge graph constructed directly from the corpus may help mitigate issues related to incomplete contextual understanding and rigid schema limitations. Because the graph is derived from the actual language and relationships expressed in the source material, it may more accurately reflect the structure and semantics of the domain, even as the domain evolves. This may be particularly beneficial in dynamic environments (e.g., regulatory contexts) where new guidance and rules are introduced over time.

By linking each relational unit to its source text, the system may preserve provenance and enable traceability, which can be useful in domains where users may wish to verify the basis of a response. This linkage may also support more consistent and contextually grounded answers across related queries, as the system can retrieve not only the relational units but also the associated textual evidence.

Embedding the relational units into a vector space may facilitate efficient and semantically meaningful retrieval. Because the embeddings are based on concise relational structures (e.g., subject-predicate-object triplets), the retrieval process may be less susceptible to noise and ambiguity than approaches that rely solely or primarily on unstructured text. In some implementations, this may reduce the likelihood of generating responses that are not grounded in the underlying data (e.g., hallucinated outputs).

The ability to project user queries into the same embedding space and compare them against embedded relational units may allow the system to identify relevant information with greater precision. This may improve the alignment between the query and the retrieved content, which can be helpful in applications where factual accuracy and semantic relevance are important.

In some implementations, the system may include visualization features that present portions of the knowledge graph in a graphical user interface. These visualizations may depict relational units (e.g., subject-predicate-object triplets) as interconnected nodes and edges, allowing users to explore the relationships among entities in an intuitive manner. A selected entity (e.g., a subject or object) may be repositioned as the central node, with related entities and predicates displayed around it. This may enable users to navigate through the graph by interacting with specific elements, such as double-clicking a node to reveal additional connections.

Such visualization features may facilitate improved comprehension of the underlying data and relationships, particularly in domains where the information is complex or highly interrelated. By surfacing the structure of the knowledge graph, the system may support exploratory analysis, assist in identifying relevant context, and enhance user confidence in the system's outputs. In some cases, these visualizations may also aid in identifying patterns or dependencies that are not readily apparent from the raw text alone.

Having just described some of the various high-level features and benefits of the disclosed embodiments, attention will now be directed to the Figures, which illustrate various conceptual representations, architectures, methods, and/or supporting illustrations related to the disclosed embodiments.

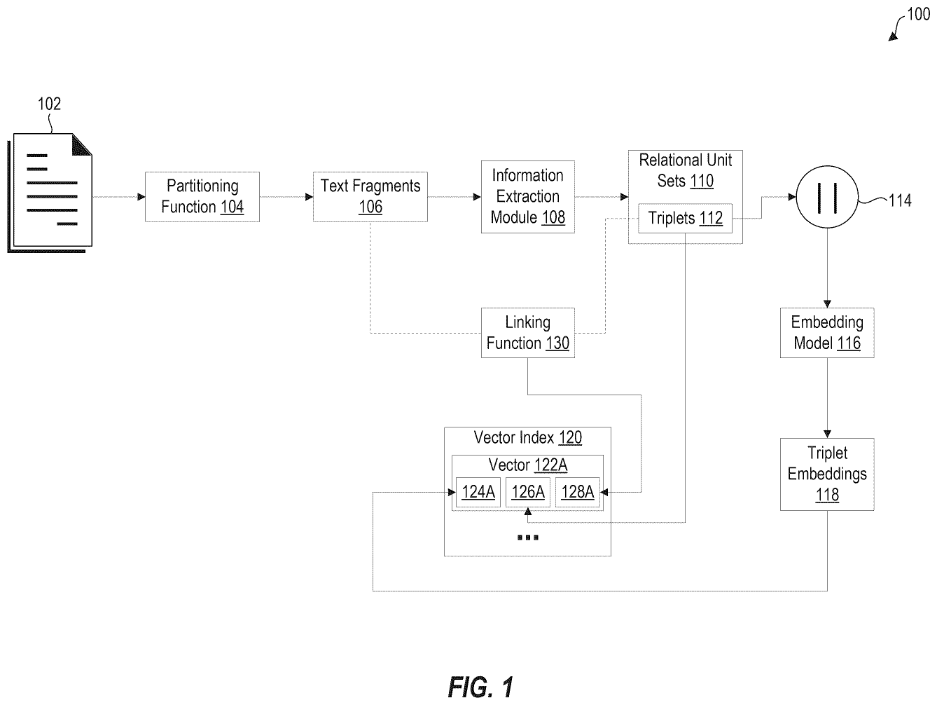

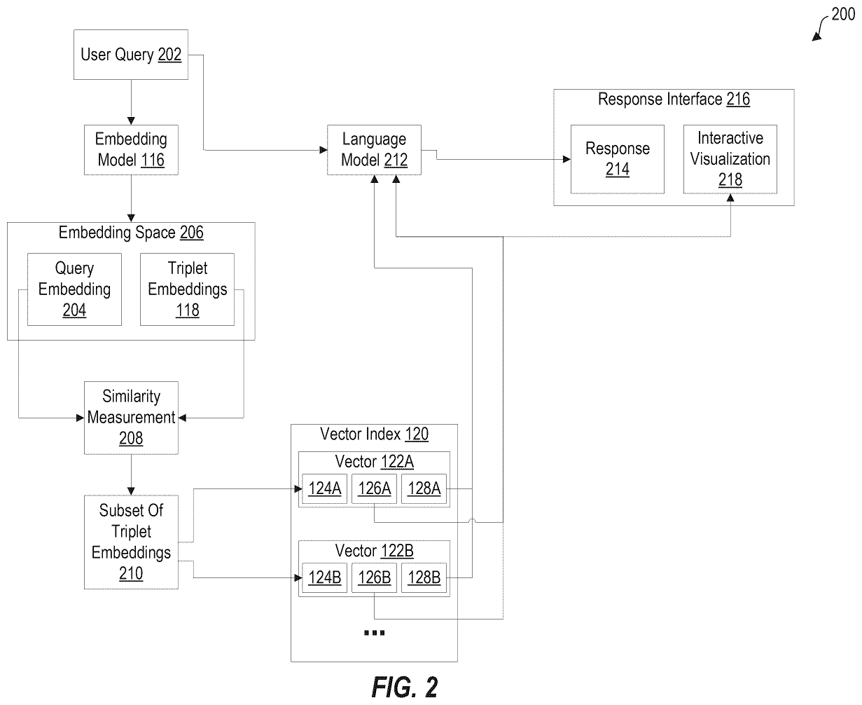

FIGS. 1 and 2 illustrate example flow diagrams 100 and 200, respectively, depicting various operations, components, data objects, and/or other aspects associated with the disclosed subject matter.

Flow diagram 100 conceptually depicts a document corpus 102, which may include a collection of documents relevant to a particular domain or application. The document corpus 102 may include unstructured or semi-structured text, such as regulatory guidance, technical manuals, legal codes, compliance documentation, or other domain-specific materials. In some implementations, the corpus may include documents issued by regulatory bodies, such as governmental agencies, standards organizations, or internal compliance departments. For example, in a healthcare or life sciences context, the corpus may include documents from the U.S. Food and Drug Administration (FDA), the Electronic Code of Federal Regulations (eCFR), or other sources of regulatory requirements.

The document corpus 102 may be stored in one or more data repositories, which may be local or cloud-based, and may be accessed by the system for processing. In some implementations, the corpus may be updated periodically or in response to changes in the underlying regulatory landscape. For instance, when a governing body issues a new rule or revises an existing guideline, the corresponding document may be added to or updated within the corpus. The system may be configured to detect such updates and incorporate them into downstream processing workflows, such as knowledge graph construction or retrieval indexing. This may allow the system to remain aligned with the most current version of the domain knowledge without requiring manual reconfiguration.

Flow diagram 100 conceptually depicts processing of the document corpus 102 via a partitioning function 104 configured to partition the document corpus 102 into text fragments 106. The text fragments 106 may comprise atomic text sections, such as paragraphs, clauses, or other semantically coherent units of text. These fragments may serve as foundational units for downstream processing, including information extraction and knowledge graph construction.

The partitioning function 104 may be implemented using one or more software modules configured to analyze the structure and content of the documents in the corpus. In some implementations, the partitioning function 104 may apply rule-based logic, natural language processing (NLP) techniques, or a combination thereof to identify logical boundaries within the text. For example, the function may detect paragraph breaks, sentence delimiters, and/or semantic cues (e.g., section headers, enumerated lists, or regulatory clause markers) to segment the text into discrete fragments.

The partitioning function 104 may operate in a batch mode or as part of a streaming pipeline, depending on the system architecture. In some cases, the function may capture metadata associated with each fragment, such as document identifiers, section numbers, and/or source references, which may be preserved for use in later stages of processing. This metadata may support traceability and facilitate alignment between the extracted relational units and their original context within the document corpus 102.

Flow diagram 100 conceptually depicts processing of the text fragments 106 via an information extraction module 108 to obtain relational unit sets 110. In the example shown, the relational unit sets 110 comprise triplets 112 that indicate subject-predicate-object relationships extracted from the text fragments 106. Each of the triplets 112 may be based on a respective set of one or more text fragments 106, and may represent a discrete semantic relationship expressed in the underlying source material.

For example, in a regulatory context, a text fragment from the Electronic Code of Federal Regulations (eCFR) might state: “The manufacturer shall submit an adverse event report within 15 days.” From this fragment, the information extraction module 108 may generate a triplet such as (“manufacturer”, “shall submit”, “adverse event report within 15 days”). This triplet captures the core relationship expressed in the text and may be used as a building block for constructing a knowledge graph.

The information extraction module 108 may be implemented using one or more natural language processing (NLP) models configured to identify and extract relational structures from structured and/or unstructured text. In some implementations, the information extraction module 108 may employ a language model (e.g., a transformer-based model) fine-tuned for relation extraction tasks. The model may be configured to detect subject, predicate, and object components within a sentence or clause, and to output structured representations of those relationships. The information extraction module 108 may also include pre-processing and post-processing components, such as tokenization, entity normalization, and filtering logic to improve the quality and consistency of the extracted triplets 112.

In some cases, the information extraction module 108 may operate in conjunction with a document ingestion pipeline (e.g., which may include the partitioning function 104) that provides contextual metadata (e.g., document source, section number, or timestamp) to be associated with each extracted triplet. This metadata may be preserved for use in downstream processes, such as embedding, retrieval, or visualization. Additionally, the information extraction module 108 may perform post-processing operations on the extracted triplets to improve consistency and quality. For example, the information extraction module 108 may apply deduplication logic to identify and merge duplicate triplets that express the same semantic relationship across different portions of the corpus. In some instances, the module 108 may also normalize entity references (e.g., resolving synonyms or formatting variations) and/or standardize predicate expressions to reduce fragmentation in the resulting knowledge graph. These operations may help ensure that the finalized triplets 112 used for triplet embedding generation are clean, consistent, and representative of the underlying relationships expressed in the document corpus 102.

Although one or more examples provided herein focus, in at least some respects, on the relational unit sets 110 comprising triplets 112 (e.g., subject-predicate-object structures), other types of relational units could be used in alternative implementations. For instance, a relational unit set may include quadruples or higher-order tuples that incorporate additional contextual elements such as time, location, or modality (e.g., subject-predicate-object-time). In some cases, relational unit sets 110 may be expressed as dependency paths, semantic role labels, and/or frame-based representations derived from linguistic and/or domain-specific ontologies. These alternative structures may be selected based on the nature of the source material, the requirements of downstream processing tasks, and/or the desired level of semantic granularity.

Flow diagram 100 conceptually depicts a linking function 130 that may map each of the triplets 112 to the respective set of text fragments 106 on which the triplet is based. This mapping may preserve a connection between each extracted relational unit and the original source material from which it was derived, thereby maintaining provenance. Maintaining provenance in this manner may allow the system to trace each of the triplets 112 back to its textual origin, which can be beneficial for various purposes, such as supporting transparency in how responses are generated, enabling users to verify the basis of a given answer, and/or facilitating auditing or review processes in domains where traceability is important (e.g., regulatory compliance).

The linking function 130 may be implemented as a data structure or mapping function that associates each of the triplets 112 with one or more identifiers corresponding to the relevant text fragments 106. In some implementations, the linking function 130 may be embodied as a hash map, relational database, or embedded metadata structure that is generated during the information extraction process. For instance, when the information extraction module 108 generates a triplet from a given text fragment, it may also record a reference to the fragment's location within the document corpus 102. This reference may include document identifiers, section numbers, or character offsets, and may be stored alongside the triplet for use in downstream retrieval, visualization, and/or explanation tasks.

Flow diagram 100 conceptually depicts combination of elements of each of the triplets 112 via an operator 114. For a given triplet, the operator 114 may be configured to combine the subject, predicate, and object elements to form a combined representation. This combined representation may take on various forms, such as a simple concatenation of the elements, a structured template, a learned transformation using an encoder, and/or others. In some implementations, the operator 114 may concatenate the elements using a delimiter or fixed format to preserve the semantic structure of the triplet.

For example, the triplet (“manufacturer”, “shall submit”, “adverse event report within 15 days”) may be combined into a single string representation such as “manufacturer shall submit adverse event report within 15 days.” This combined representation may then be used as input to an embedding model or other downstream processing component. The operator 114 may perform this operation for each individual triplet of the triplets 112, resulting in multiple combined representations corresponding to the respective relational unit sets 110.

Flow diagram 100 conceptually depicts processing of the combined representations formed via operator 114 by an embedding model 116 to form triplet embeddings 118 in an embedding space, such as a high-dimensional vector space. Each triplet embedding of the triplet embeddings 118 may correspond to a respective combined representation derived from one of the triplets 112.

The embedding model 116 may be implemented using a neural network architecture, such as a transformer-based model or other model capable of encoding textual input into vector representations. In some implementations, the embedding model 116 may be a custom embedding model trained on domain-specific textual data, such as regulatory documents from the Electronic Code of Federal Regulations (eCFR), internal compliance manuals, and/or other relevant corpora. Training the model on such data may enable it to capture semantic nuances and terminology specific to the domain of interest.

Flow diagram 100 conceptually depicts constructing a vector index 120, which may include any number of vectors, as indicated by the ellipsis. In some implementations, the vector index 120 may include one vector for each of the triplet embeddings 118 or for each of the triplets 112 extracted from the document corpus 102. An example vector 122A is shown in flow diagram 100 and includes a triplet embedding 124A, a triplet 126A, and a set of text 128A (or an indication of the set of text 128A).

The triplet embedding 124A may comprise the triplet embedding (e.g., of the triplet embeddings 118) generated by processing the triplet 126A using the embedding model 116. For example, the triplet 126A may be combined into a single representation (e.g., via concatenation) and then embedded into a high-dimensional vector space to form the triplet embedding 124A. The set of text 128A may correspond to the text fragment or fragments (e.g., from text fragments 106) from which the triplet 126A was originally extracted. This association may be indicated using the linking function 130, which may maintain provenance between the relational units and their source material.

Vectors with similar structure and content may be constructed for each of the triplets 112 and stored in the vector index 120. Collectively, the vector index 120 (and/or components of the vectors thereof) may serve as an ontology-free knowledge graph, where each vector encodes a semantically meaningful relationship along with its textual context and embedding. This structure may support efficient semantic search and retrieval, allowing user queries to be projected into the same embedding space and compared against the triplet embeddings to identify relevant content. As described in greater detail hereinbelow, this may facilitate retrieval-augmented generation and/or other downstream applications.

In some implementations, a single triplet embedding may be associated with multiple sets of text from the document corpus, reflecting instances where the same semantic relationship appears in different contexts. Conversely, a single text fragment may give rise to multiple distinct triplets. This many-to-many mapping may be captured in the vector index 120 and may enhance retrieval robustness by allowing the system to surface all relevant textual evidence associated with a given relational unit. Such mapping may support broader contextualization during response generation, as the language model may be provided with multiple perspectives or formulations of the same underlying relationship.

FIG. 2 depicts a flow diagram 200 showing aspects of generating a response to a user query via knowledge graph-enhanced retrieval augmented generation. Flow diagram 200 conceptually depicts a user query 202, which may represent a request for information submitted by a user. The user query 202 may be provided in various formats, such as typed text entered into a graphical user interface, voice input processed by a speech recognition system, or other suitable input modalities. The content of the user query 202 may vary depending on the domain and use case. For example, in a regulatory compliance context, the query may ask, for example, “What is the required timeframe for submitting an adverse event report?” or “Which agency oversees Regulation 2025-X?”

The user query 202 may be processed by an embedding model 116, which may comprise the same embedding model 116 used to construct the vector index 120 as described above with reference to flow diagram 100. The embedding model 116 may project the user query 202 into an embedding space 206 to generate a query embedding 204. The embedding space 206 may be the same embedding space into which the triplet embeddings 118 are projected, allowing for comparison between the query embedding 204 and the triplet embeddings stored in the vector index 120. This shared embedding space may facilitate semantic similarity analysis and support retrieval of relevant relational units and associated text based on the content of the user query.

Flow diagram 200 conceptually depicts similarity measurement 208, which may be performed to determine similarity between the query embedding 204 and the triplet embeddings 118 within the embedding space 206. The similarity measurement 208 may take on various forms, such as cosine similarity, dot product, Euclidean distance, or other distance or similarity metrics suitable for comparing high-dimensional vectors. The choice of similarity metric may depend on the characteristics of the embedding space 206 and the embedding model 116 used to generate the vectors.

The similarities determined via similarity measurement 208 may be used to identify a subset of triplet embeddings 210 that are relevant to the user query 202. In some implementations, this may be performed using a k-nearest neighbor (k-NN) search, where the top k triplet embeddings 118 with the highest similarity scores relative to the query embedding 204 are selected. This approach may allow the system to efficiently retrieve relational units that are semantically aligned with the query. Alternative approaches to identifying the subset of triplet embeddings 210 may include threshold-based filtering (e.g., selecting all embeddings with similarity above a predefined value), approximate nearest neighbor search using locality-sensitive hashing or vector quantization, clustering-based retrieval methods that group embeddings into semantically coherent regions of the embedding space, and/or others.

Flow diagram 200 conceptually depicts that the subset of triplet embeddings 210 identified via similarity measurement 208 may be used to determine corresponding triplets and basis text via the vector index 120. These triplets and associated text may then be used as inputs to a language model 212, along with the user query 202, to facilitate generation of a response 214 to the user query 202.

In the example shown in flow diagram 200, the subset of triplet embeddings 210 includes triplet embedding 124A and triplet embedding 124B. Flow diagram 200 further depicts triplet embedding 124A as being associated with triplet 126A and set of text 128A via vector 122A in the vector index 120. This indicates that triplet 126A and set of text 128A likely have semantic relevance to the user query 202, as determined by the similarity measurement 208 between the query embedding 204 and triplet embedding 124A. Similarly, triplet embedding 124B is shown as being associated with triplet 126B and set of text 128B via vector 122B in the vector index 120.

Flow diagram 200 illustrates that the triplets and basis text determined to be relevant to the user query 202 (e.g., via the query embedding 204 and the similarity measurement 208) may be used as input to a language model 212 for generating a response 214 to the user query 202. As shown in flow diagram 200, triplet 126A, set of text 128A, triplet 126B, and set of text 128B are provided to the language model 212 along with the user query 202.

Providing both the triplets and their corresponding sets of text to the language model 212 (along with the user query 202) may be beneficial for various reasons. For instance, the triplets may serve as a structured representation of the core relationships expressed in the source material, while the associated text may provide additional context and detail. By combining these inputs, the language model 212 may be better equipped to generate responses that are both semantically aligned with the query and grounded in the underlying data. This approach may reduce the likelihood of hallucinated or imprecise outputs and may improve traceability, as the response can be linked back to specific relational units and source text. This combination of structured and unstructured inputs may enhance the ability of the language model 212 to navigate complex domains and maintain consistency across related queries.

In some implementations, the triplets identified as relevant to a user query may form a subgraph of interconnected relationships that can be navigated to support follow-up questions or deeper exploration (e.g., facilitated via a response interface 216, as described hereinafter). For example, the system may identify additional triplets that share entities with those initially retrieved, allowing users to traverse related concepts through structured semantic links. This subgraph navigation may be facilitated by the underlying triplet structure, which inherently captures directional relationships between entities. Such navigation may support multi-hop reasoning, contextual expansion, and iterative refinement of responses, particularly in domains where information is distributed across multiple documents or expressed in layered regulatory language.

The language model 212 may be implemented using a generative neural network architecture, such as a transformer-based model trained for question answering or text generation tasks. In some implementations, the model may be fine-tuned on domain-specific data to improve its performance in specialized contexts (e.g., regulatory compliance, healthcare, legal analysis). The model may be configured to accept multiple input types, including natural language queries, structured relational data, and/or supporting text, and to generate fluent, contextually relevant responses based on those inputs.

Flow diagram 200 conceptually depicts that the response 214 generated via the language model 212 may be presented via a response interface 216. The response interface 216 may be implemented as a graphical user interface presented on a user interface frontend, such as a web application, a downloadable desktop or mobile application, or any other suitable software interface. The frontend may be accessed via various devices, including desktop computers, laptops, tablets, smartphones, and/or others. The response interface 216 may be configured to receive the user query 202 and present the corresponding response 214 in a readable and/or interactive format.

Within the response interface 216, a representation of the response 214 may be accompanied by an interactive visualization 218. The interactive visualization 218 may present subject-predicate-object relationships represented by the triplets identified as being relevant to the user query 202. For example, flow diagram 200 conceptually depicts triplets 126A and 126B as inputs for generating the interactive visualization 218, as shown by arrows extending from those triplets to the visualization component. The interactive visualization 218 may display these relationships as interconnected nodes and edges, allowing users to explore the semantic structure of the retrieved information. Such an interactive visualization 218 may enhance user comprehension and support intuitive navigation of complex relational data.

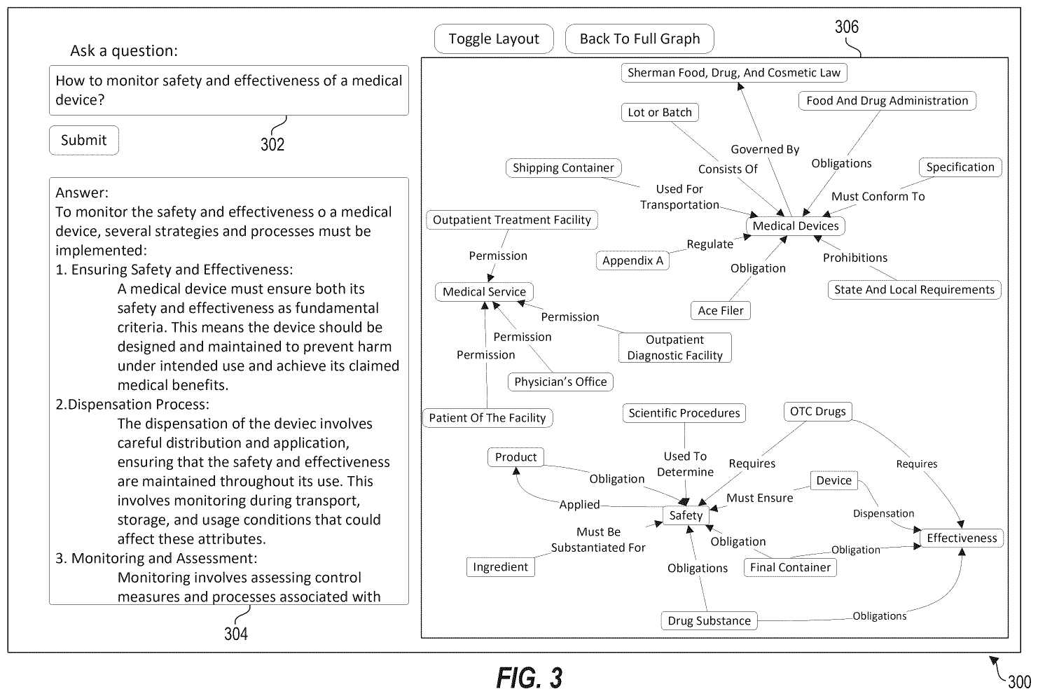

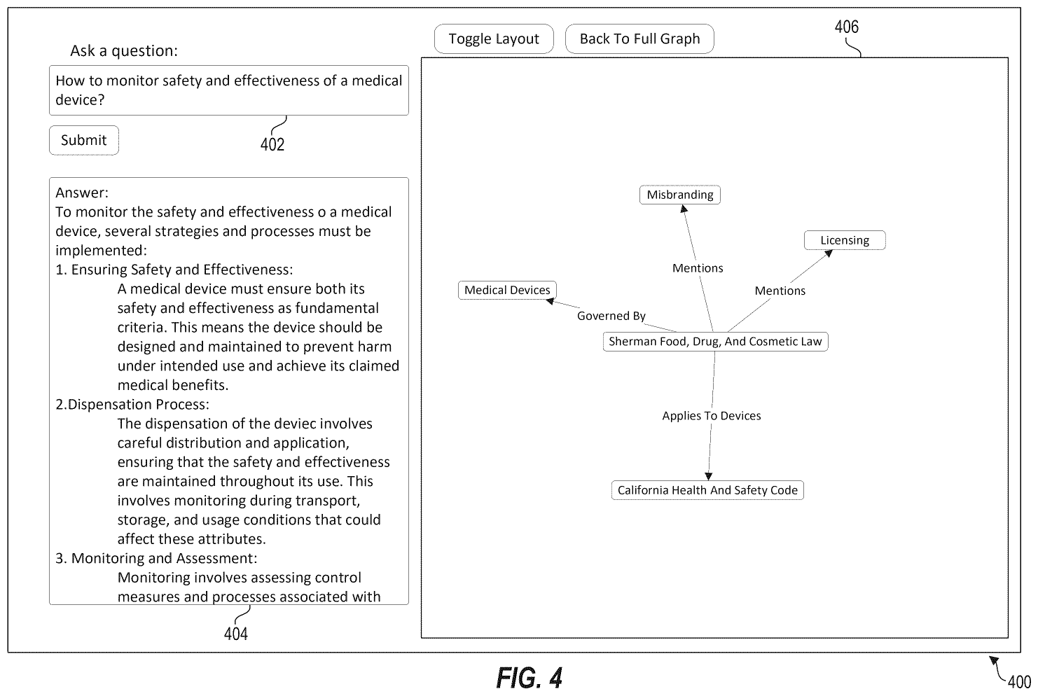

FIGS. 3 and 4 illustrate conceptual representations of user interfaces 300 and 400, respectively, associated with the disclosed subject matter.

FIG. 3 illustrates a conceptual representation of a user interface 300, which may be presented via a graphical user interface for interaction by one or more users. The user interface 300 may be displayed via a user interface frontend, such as a web-based application, a desktop or mobile application, or any other suitable software interface accessible on devices including laptops, tablets, smartphones, smart displays, etc.

In the example shown, the user interface 300 includes a query region 302, whereby a user may enter a query. The query may be provided as typed text input or through other input modalities such as voice input, touch-based selection, or gesture-based interaction. The query region 302 may support natural language queries relevant to the domain of interest (e.g., regulatory compliance, technical documentation, etc.).

The user interface 300 also includes a response region 304, whereby a response to the user query represented in the query region 302 may be presented. The response region 304 may display the output generated by the system (e.g., via a language model), including textual answers, citations, and/or other supporting information. Although the example shown in FIG. 3 depicts the query region 302 and response region 304 as visually represented components, other modalities are possible. For instance, the system may be implemented within a spoken dialogue framework, where the user provides the query aloud and the system responds via synthesized speech output. In such implementations, the query and/or the response may not be visually represented, and interaction may occur through audio-based input and output.

The example user interface 300 shown in FIG. 3 includes an interactive visualization 306, which may correspond to the interactive visualization 218 described above with reference to FIG. 2. The interactive visualization 306 may be presented in conjunction with the response region 304, such that the response region 304 and the interactive visualization 306 together form the response interface 216. In this configuration, the user may view both the generated response and a graphical representation of the underlying relational data used to generate that response.

The interactive visualization 306 may present subject-predicate-object relationships associated with one or more triplets identified as relevant to the query represented in the query region 302. The relevant triplet(s) may be identified using techniques described hereinabove (e.g., embedding the user query and comparing it to embedded triplets via similarity measurement) or other techniques, such as rule-based keyword matching, manually curated mappings, and/or other approaches. In the example shown in FIG. 3, the interactive visualization 306 presents subjects and objects of the identified subject-predicate-object relationships as nodes with text labels (e.g., “Ace Filer,” “Appendix A,” “Medical Devices”, “Medical Service”, “Physician's Office”, “Safety”, “Drug Substance”, “Effectiveness”). Predicates of the identified subject-predicate-object relationships are presented in the interactive visualization 306 as edges that connect the nodes and that include text labels (e.g., “Obligation,” “Regulate”, “Governed By”, “Permission”, “Requires”, “Must Ensure”). This type of interactive visualization 306 may enable users to intuitively explore the relationships among entities relevant to their query.

FIG. 3 illustrates that the interactive visualization 306 may include edges comprising features that indicate the subject-object relationships of the nodes connected by the edges. For example, the edges shown in the interactive visualization 306 include arrow heads directed toward the object of each subject-predicate-object relationship, visually conveying the directionality of the relationship. By way of illustration, the interactive visualization 306 depicts a node labeled “Ace Filer” (representing a subject) connected by an edge labeled “Obligation” (representing a predicate) to a node labeled “Medical Devices” (representing an object). This graphical arrangement represents a subject-predicate-object relationship associated with a triplet identified as relevant to the user query.

Nodes within the interactive visualization 306 may represent subjects and/or objects of the identified relationships. A single node may participate in multiple subject-predicate-object relationships. For instance, a node may represent a subject in more than one relationship (e.g., the “Device” node representing a subject related to “Safety” and “Effectiveness” objects), an object in more than one relationship (e.g., the “Medical Service” node representing an object related to “Physician's Office” and “Outpatient Diagnostic Facility” subjects), or both a subject and an object (e.g., the “Medical Devices” node representing a subject related to the “Sherman Food, Drug, and Cosmetic Law” object and representing an object related to the “Food And Drug Administration” subject). In some implementations, multiple edges may connect two nodes, indicating that the two nodes share multiple subject-predicate-object relationships (e.g., the “Product” node and the “Safety” node are connected by both “Obligation” and “Applied” nodes). This type of interconnected structure may allow users to explore how entities are related across different contexts and may support intuitive navigation through the underlying relational data.

The interactive visualization 306 shown in FIG. 3 may be presented within the user interface 300 using a dynamic viewport. A dynamic viewport may refer to a scrollable, zoomable, pannable, or otherwise modifiable display region that allows users to interact with and explore different portions of the visualization in real time. This can be helpful when the graph of subject-predicate-object relationships is large or complex, containing numerous nodes and edges that may not fit within a static display area while maintaining interpretability.

By enabling dynamic navigation, the viewport may allow users to intuitively focus on specific entities or relationships, follow connections between related nodes, and/or drill down into areas of interest without losing context. For example, a user may zoom in on a particular node to examine its associated relationships in detail, or pan across the graph to explore how different entities are interconnected. This type of interface may improve interpretability and usability, especially in domains where the underlying data is dense or highly interrelated.

FIG. 3 illustrates that some of the nodes shown in the interactive visualization 306 are presented as central nodes, with related nodes arranged around each central node. These central nodes may represent entities (e.g., subjects or objects) that are represented in multiple subject-predicate-object relationships determined to be relevant to the user query represented in the query region 302 (e.g., via embedding similarity measurement or other relevance scoring techniques).

For example, the interactive visualization 306 depicts “Medical Devices”, “Medical Service”, “Safety”, and “Effectiveness” as central nodes in response to the user query: “How to monitor safety and effectiveness of a medical device?” Based on the semantic content of the query and the similarity analysis performed during retrieval, the system may identify multiple triplets involving the entities “Medical Devices”, “Medical Service”, “Safety”, and “Effectiveness”. As a result, the “Medical Devices”, “Medical Service”, “Safety”, and “Effectiveness” nodes may be positioned centrally in the interactive visualization 306, with related entities arranged at positions surrounding the central nodes. This layout may help users visually interpret the relationships pertinent to their query.

In some instances, systems may be configured to receive user input directed to nodes of the interactive visualization 306 to facilitate user analysis of information related to their query. For instance, the interactive visualization 306 may be configured to receive a first type of user input (e.g., pointer hover input, short press, long press) directed to a node to trigger surfacing of additional information related to the entity represented by the node, such as one or more properties of the entity (e.g., subject and/or object), including categories or classifications of the entity (e.g., “organization”, “authority”, “institution”, “law”, “object”, “concept”, “product”, “device”, etc.). As another example, the interactive visualization 306 may be configured to receive a second type of user input (e.g., short press, long press, click) selecting a node to trigger modification of the relationships presented in the interactive visualization to provide additional information related to the selected node.

FIG. 4 illustrates a graphical user interface 400 that may be presented following selection of the “Sherman Food, Drug, And Cosmetic Law” node from interactive visualization 306 (e.g., via the second type of user input). Similar to the graphical user interface 300, the graphical user interface 400 includes a query region 402, a response region 404, and an interactive visualization 406. In this example, the interactive visualization 406 depicts the “Sherman Food, Drug, And Cosmetic Law” node as a central node and presents additional relationships not shown in interactive visualization 306, such as new subject nodes, object nodes, and/or predicate edges related to “Sherman Food, Drug, And Cosmetic Law” (e.g., the “California Health And Safety Code” node and corresponding edge labeled “Applies To Devices” is added, among others). These additional relationships (e.g., with the “Sherman Food, Drug, And Cosmetic Law” node shown as a central node) may be determined and/or presented based on the selection of the “Sherman Food, Drug, And Cosmetic Law” node in the interactive visualization 306.

In addition to presenting known relationships, the interactive visualizations 306 and/or 406 may serve as a discovery tool that helps users uncover connections not immediately apparent from the query or response text. By interacting with nodes and edges, users may identify related entities, procedural dependencies, or overlapping obligations that span multiple documents. The visualization may also support query refinement by allowing users to shift focus to a different entity or relationship, which may trigger automatic generation of a new query and corresponding response. This exploratory capability may be particularly useful in domains where users are unfamiliar with the terminology or structure of the underlying data.

Agentic AI and multi-agent techniques may be incorporated into various aspects of the operations and system workflows described herein to support modularity, scalability, and intelligent orchestration of tasks. In some implementations, the system may include multiple specialized agents, each configured to perform a distinct function within the overall question answering framework. For example, a document ingestion agent may segment and annotate incoming documents, a triplet extraction agent may identify subject-predicate-object relationships, and a normalization and cleaning agent may resolve duplicates and standardize entity references. Additional agents may include a triplet store and indexing agent for embedding and storing relational units, a retrieval agent for identifying relevant triplets based on query embeddings, a story-building agent for assembling supporting context, and a generation agent for producing final responses. These agents may operate independently or in coordination, allowing the system to dynamically orchestrate tasks, adapt to evolving data, and maintain modular scalability.

These agents may operate independently or in coordination, allowing the system to dynamically allocate resources and adapt to changing inputs or operational contexts. For instance, upon receiving a user query, an agent may first perform intent classification to determine whether the query pertains to regulatory information. If the query is determined to be outside the scope of the regulatory domain, the agent may explicitly communicate this to the user, thereby avoiding speculative or unfounded responses. In scenarios where sufficient relevant context has already been retrieved (e.g., carried over from prior interactions), the agent may bypass additional retrieval operations and proceed directly to response generation, thereby reducing latency and avoiding redundant tool invocations. When additional context is needed, the agent may invoke a hybrid retrieval strategy that includes both keyword-based retrieval (to capture direct textual matches within the knowledge graph-enhanced RAG corpus) and semantic retrieval (to identify conceptually related clauses based on embeddings of triplets and raw text). This dual approach may improve both precision and recall in surfacing relevant regulatory content. During answer construction, the agent may integrate information from both sources of evidence, including graph-based reasoning over pre-extracted triplets to capture structural regulatory constraints, and raw text grounding to cite verbatim clauses for traceability and auditability. Agents may also monitor for redundancy or overlap in retrieved content and suppress unnecessary operations to streamline performance.

In some cases, agentic orchestration may also support iterative refinement, where agents evaluate the quality of extracted triplets, update the knowledge graph as new documents are ingested, or adjust retrieval parameters based on user feedback or system performance. This modular approach may facilitate continuous improvement of the system without requiring full reprocessing of the corpus or retraining of models. Additionally, agentic coordination may enable integration of visualization components, such as determining which nodes to present as central in the interactive visualization based on query relevance or user interaction history.

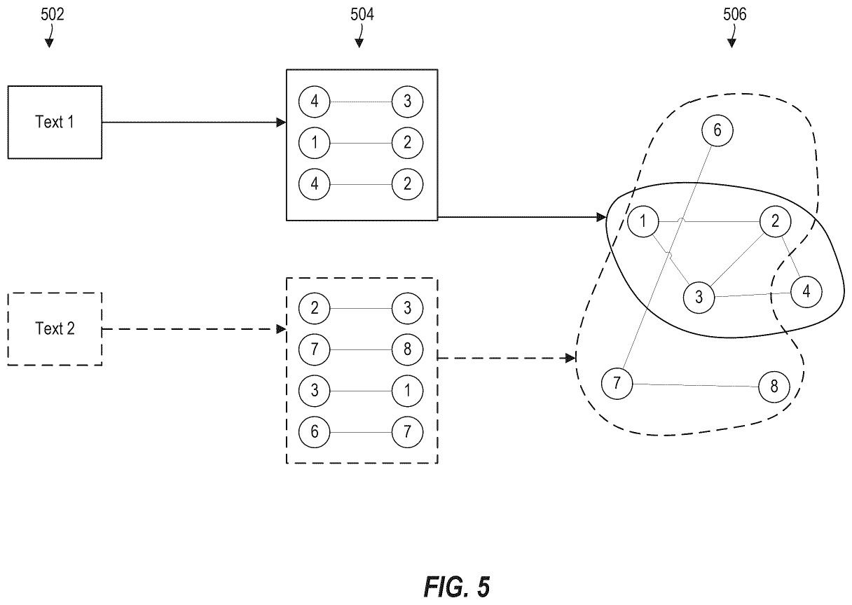

FIG. 5 illustrates a conceptual representation of graphing of triplets extracted from a document corpus. As shown, example text sections 502 (e.g., “Text 1” and “Text 2”) may be processed to extract triplets 504 that represent subject-predicate-object relationships expressed in the underlying text. The triplets 504 are depicted as node-link-node structures, where each node corresponds to an entity (e.g., subject or object) and each edge corresponds to a predicate linking the entities. For example, triplets 4-3, 1-2, and 4-2 are shown as extracted from Text 1, while triplets 2-3, 7-8, 3-1, and 6-7 are shown as extracted from Text 2.

As illustrated, individual nodes may participate in multiple triplets, thereby forming interconnections among relational units. For instance, node “2” is shown as belonging to triplets 1-2 and 4-2 from Text 1, as well as triplet 2-3 from Text 2. FIG. 5 further depicts a graph 506 that visually represents these interconnections, allowing users or system components to observe how entities are semantically linked across different portions of the corpus. The graph 506 may facilitate identification of overlapping relationships and shared entities, which may support multi-hop reasoning, contextual expansion, or traceability across documents.

As noted above, deduplication may be performed on the extracted triplets 504 to reduce redundancy and optimize the retrieval space. The graph 506 may reflect such deduplication by collapsing semantically equivalent triplets and preserving unique relational structures. As shown in FIG. 5, the graph 506 includes a solid boundary encompassing triplets extracted from Text 1 and a dashed boundary encompassing triplets extracted from Text 2. These boundaries may visually distinguish the provenance of relational units while still allowing for cross-text connectivity. For example, the presence of node “2” within both boundaries illustrates how a single entity may serve as a semantic bridge between different text sections, thereby interconnecting the underlying source material.

The following examples/experiments are provided to further illustrate certain aspects of the disclosed subject matter and are not intended to limit the scope of the disclosed subject matter in any way. The examples/experiments were conducted under particular conditions designed, and the data, metrics, and outcomes are provided for illustrative purposes and may vary in other implementations depending on implementation details, system configurations, and input data characteristics.

The following methodology was employed to evaluate the ability of the disclosed systems, methods, and techniques to (1) retrieve the correct sections of a regulatory corpus, (2) generate factually accurate answers and (3) demonstrate flexibility of navigation through the interconnection of triplets in related sections. The following discussion sets forth the sampling procedure, the construction of queries, the measurement of section-level overlap, the assessment of factual correctness, and the analysis of triplet-based navigation for the examples/experiments.

### Sampling and Ground Truth Construction

Random Sampling of Sections: Let S={s₁, s₂, . . . , s_{N}} be the full set of sections of the regulatory corpus. Random subsets are drawn:

$${S}^{′} = \{ {s}_{i 1} , {s}_{i 2} , … , {s}_{i k} \} ⊂ S ,$$

where each sᵢⱼ is considered a target section for evaluation, and k<<N.

Identifying All Ground Truth Mentions: For each sampled section sᵢⱼ, all other sections in the corpus that reference or expand upon the same regulatory ideas or entities are located. Formally,

$$M ( {s}_{ij} ) = \{ {s}_{m 1} , {s}_{m 2} , … \}$$

denotes the set of sections that contain overlaps or references relevant to sᵢⱼ. A re-told story is created by concatenating sᵢⱼ with all sections in M(sᵢⱼ):

$${\tilde{s}}_{i j} = ( {s}_{i j} ‖ {s}_{m 1} \vert \vert {s}_{m 2} ‖ … ) .$$

This concatenated text \tilde{s}ᵢⱼ is treated as the ground truth context for the focal sections sᵢⱼ.

### LLM-Generated Questions and Answers

A Large Language Model, denoted LLM_{gen}, is used to produce a set of questions and corresponding reference answers based on each concatenated text \tilde{s}ij. Formally,

$$( {Q}_{ij} , {A}_{ij} ) = L L {M}_{g e n} ( {\tilde{s}}_{ij} ) ,$$

where Qᵢⱼ={q₁, q₂, . . . , qₘ} and Aᵢⱼ={a₁, a₂, . . . , aₘ}. Each pair (qᵣ, aᵣ) is presumed to be responsible via the original information in \tilde{s}ᵢⱼ.

### System Inference and Evaluations

Section-Level Overlap: To answer each question qᵣ∈Qᵢⱼ, system retrieves a set of sections R_{ij,r} deemed relevant (based on embedding retrieval, triplet matching, or both). The level of overlap between the recovered sections R_{ij,r} and the ground truth target section sᵢⱼ (along with its reference set M(sᵢⱼ)) is measured.

Definition: Overlap Score: Let Gᵢⱼ={sᵢⱼ}∪M(sᵢⱼ) be the set of ground truth sections. Suppose that the system returns R_{ij,r}={r₁, r₂, . . . , rₗ}. The overlap score O for question qᵣ is defined as

$$O ( {R}_{ij , r} , {G}_{ij} ) = \frac{\vert {R}_{ij , r} ∩ {G}_{ij} \vert}{\vert {R}_{ij , r} \vert}$$

### Thus,

if R_{ij,r}∩Gᵢⱼ=Ø, then O=0;
if R_{ij,r} returns exactly one section, r₁, and r₁=sᵢⱼ, then O=1; and
if, for instance, the system returns three sections, only one of which matches any in Gᵢⱼ, then O=⅓.

This measure may be further refined by applying a similarity threshold θ for the equivalence between the retrieved sections and the ground truth sections (e.g., if the sections partially overlap or are highly similar). In that case,

$$\vert {R}_{ij , r} ∩ {G}_{ij} \vert = {\sum }_{r ∈ {R}_{ij , r}} 1 [ sim ( r , {s}_{g} ) \geq θ for some {s}_{g} ∈ {G}_{ij} ] .$$

Factual Correctness of Answers: Once the system retrieves relevant sections and processes them through the QA pipeline (with or without associated triplets), it produces an answer a*ᵣ. We compare a*ᵣ with the reference answer aᵣ from LLM_{gen}.

LLM-Based Fact Checking: A secondary evaluation model LLMₑᵥₐₗ or a domain expert is used to assess whether a*ᵣ is factually correct with respect to the original text \tilde{s}ᵢⱼ. It is denoted that:

$$F ( {a}_{r}^{*} , {a}_{r} ) = \{ \begin{matrix}if {a}_{r}^{*} is factually correct and consistent with {a}_{γ} \\ otherwise\end{matrix} .$$

Correctness is measured with two conditions:
1. With Triplets: The system's answer is grounded in the set of triplets that directly link to the retrieved sections.
2. Without Triplets: The system response is derived purely from the retrieval of raw text, without referencing the triplet data structure.

By comparing the correctness scores for these two conditions, we quantify the impact of structured triplets in factual precision.

Navigational Facility of Triplets: Triplet interconnections may facilitate follow-up questions. In many regulatory contexts, a concept from one section leads to further questions about a related section. To do this, the following is defined.

Triplet Overlap Across Sections: Let T be the global set of extracted triplets. For sections sᵢⱼ and [symbol] ∈M(sᵢⱼ), triplets that are shared or linked between these sections may be analyzed:

$$T ( {s}_{ij} ) = \{ t ∈ T \vert t is extracted from section {s}_{ij} \} ,$$

$$T ( {s}_{m l} ) = \{ t ∈ T \vert t is extracted from section {s}_{m l} \} ,$$

The following is then analyzed:

$$T ( {s}_{ij} ) ⋂ T ( {s}_{m l} ) ,$$

which denotes shared triplets that link the heads/tail entities in sections. A single triplet may appear in multiple sections if those sections refer to the same entity relationships; or it may connect a head entity in sᵢⱼ to a tail entity in [symbol] .

Navigational Metric: A metric Nav (S′) is defined to capture average fraction of shared or sequentially linked triplets among sections that mention the same ground-truth concepts. Let

$$Nav ( {S}^{′} ) = \frac{1}{k} {\sum }_{j = 1}^{k} \frac{{\sum }_{{s}_{m l} ∈ M ( {s}_{ij} )} \vert T ( {s}_{ij} ) ⋂ T ( {s}_{m l} ) \vert}{{\sum }_{{s}_{m l} ∈ M ( {s}_{ij} )} \vert T ( {s}_{ij} ) ⋃ T ( {s}_{m l} ) \vert}$$

where a higher value indicates stronger overlap (and thus navigational facility), indicating that triplets help the system move seamlessly between related sections.

By integrating section-level overlap analysis, factual correctness checks, and a triplet interconnection navigation metric, this evaluation framework measures retrieval accuracy, answer precision, and knowledge connectivity-ensuring robust compliance support, domain-specific Q&A, and effective scalability in real-world regulatory settings.

TABLE 1
Evaluation Results for Section Overlap, Answer Accuracy, and Navigation Metrics

| Metric | Without Triplets | With Triplets |
|---|---|---|
| 1. Section Overlap (Similarity Threshold) | | |
| 0.50 | 0.0812 | 0.0745 |
| 0.60 | 0.2700 | 0.2143 |
| 0.75 (stricter) | 0.1684 | 0.2888 (highest accuracy) |
| 2. Answer Accuracy (Scale: 1-5) | | |
| Average Accuracy | 4.71 | 4.73 |
| 3. Navigation Metrics | | |
| Average Degree | 1.2939 (less interconnected) | 1.6080 (more interconnected) |
| Unconnected Sections Linked | 5014 unconnected section | 5011 connected sections |
| Avg. Shortest Path | 2.0167 (slower information flow) | 1.3300 (faster information flow) |

Table 1 compares system performance with and without triplets across three evaluation criteria: retrieval accuracy (section overlap at varying similarity thresholds), factual correctness of generated answers, and efficiency of navigation through related regulatory sections. Triplets yield highest accuracy at higher threshold. Triplets network significantly enhances connectivity and navigation.

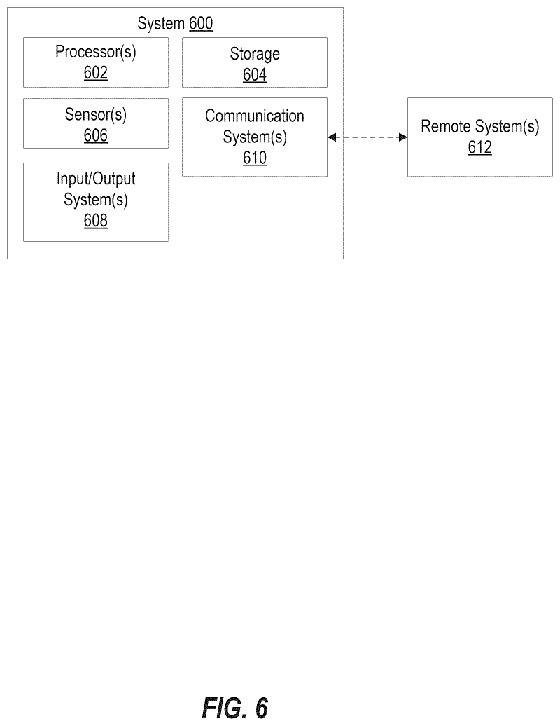

FIG. 6 illustrates example components of a system 600 that may comprise or implement aspects of one or more disclosed embodiments. For example, FIG. 6 illustrates an implementation in which the system 600 includes processor(s) 602, storage 604, sensor(s) 606, I/O system(s) 608, and communication system(s) 610. Although FIG. 6 illustrates a system 600 as including particular components, one will appreciate, in view of the present disclosure, that a system 600 may comprise any number of additional or alternative components.

The processor(s) 602 may comprise one or more sets of electronic circuitries that include any number of logic units, registers, and/or control units to facilitate the execution of computer-readable instructions (e.g., instructions that form a computer program). Processor(s) 602 can take on various forms, such as CPUs, NPUs, GPUs, or other types of processing units. Such computer-readable instructions may be stored within storage 604. The storage 604 may comprise physical system memory and may be volatile, non-volatile, or some combination thereof. Furthermore, storage 604 may comprise local storage, remote storage (e.g., accessible via communication system(s) 610 or otherwise), or some combination thereof. Additional details related to processors (e.g., processor(s) 602) and computer storage media (e.g., storage 604) will be provided hereinafter.

In some implementations, the processor(s) 602 may comprise or be configurable to execute any combination of software and/or hardware components that are operable to facilitate processing using machine learning models or other artificial intelligence-based structures/architectures. For example, processor(s) 602 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, transformer networks, generative adversarial networks, liquid state machines, extreme learning machines, echo state networks, deep residual networks, Kohonen networks, support vector machines, neural Turing machines, combinations thereof (or combinations of components thereof), and/or others.

As will be described in more detail, the processor(s) 602 may be configured to execute instructions stored within storage 604 to perform certain actions. In some instances, the actions may rely at least in part on communication system(s) 610 for receiving data from remote system(s) 612, which may include, for example, separate systems or computing devices, sensors, servers, and/or others. The communications system(s) 610 may comprise any combination of software or hardware components that are operable to facilitate communication between on-system components/devices and/or with off-system components/devices. For example, the communications system(s) 610 may comprise ports, buses, or other physical connection apparatuses for communicating with other devices/components. Additionally, or alternatively, the communications system(s) 610 may comprise systems/components operable to communicate wirelessly with external systems and/or devices (e.g., network devices, server infrastructure) through any suitable communication channel(s), such as, by way of non-limiting example, Bluetooth, ultra-wideband, WLAN, infrared communication, and/or others.

FIG. 6 illustrates that a system 600 may comprise or be in communication with sensor(s) 606. Sensor(s) 606 may comprise any device for capturing or measuring data representative of perceivable phenomenon. By way of non-limiting example, the sensor(s) 606 may comprise one or more image sensors, microphones, thermometers, barometers, magnetometers, accelerometers, gyroscopes, and/or others.

Furthermore, FIG. 6 illustrates that a system 600 may comprise or be in communication with I/O system(s) 608. I/O system(s) 608 may include any type of input or output device such as, by way of non-limiting example, a display, a touch screen, a mouse, a keyboard, a controller, and/or others, without limitation.

Disclosed embodiments include at least those presented in the following numbered clauses:

Clause 1. A system, comprising: one or more processors; and one or more computer-readable recording media that store instructions that are executable by the one or more processors such that the system is configurable to: access a user query; process the user query to generate a query embedding in an embedding space; determine a subset of relational unit set embeddings from a set of relational unit set embeddings, wherein the subset of relational unit set embeddings is determined based on similarity measurement between the query embedding and relational unit set embeddings of the set of relational unit set embeddings in the embedding space, wherein each relational unit set embedding of the set of relational unit set embeddings is associated, via a vector index, with (i) a respective relational unit set processed to generate the relational unit set embedding and (ii) an indication of a respective set of text from a document corpus on which the respective relational unit set is based; and generate a response to the user query by processing (i) the user query, (ii) the respective relational unit set associated with each relational unit set embedding of the subset of relational unit set embeddings, and (iii) the respective set of text associated with each relational unit set embedding of the subset of relational unit set embeddings as inputs to a language model.

Clause 2. The system of any preceding or subsequent clause, wherein each respective relational unit set comprises a triplet indicating subject-predicate-object relationships.

Clause 3. The system of any preceding or subsequent clause, wherein each relational unit set embedding is generated by processing a combined representation of elements of its respective relational unit set.

Clause 4. The system of any preceding or subsequent clause, wherein the combined representation comprises a concatenation of the elements.

Clause 5. The system of any preceding or subsequent clause, wherein the indication of the respective set of text from the document corpus on which the respective relational unit set is based is determined via a linking function that associates the respective relational unit set to the respective set of text.

Clause 6. The system of any preceding or subsequent clause, wherein the query embedding is generated via an embedding model trained on textual data extracted from a training document corpus.

Clause 7. The system of any preceding or subsequent clause, wherein the instructions are executable by the one or more processors such that the system is configurable to: cause presentation the response to the user query via a user interface frontend.

Clause 8. A system, comprising: one or more processors; and one or more computer-readable recording media that store instructions that are executable by the one or more processors such that the system is configurable to: access a user query; process the user query to determine a plurality of triplets indicating subject-predicate-object relationships, wherein each triplet of the plurality of triplets is generated based on a respective set of text from a document corpus; generate a response to the user query by at least by processing the user query as an input to a language model; and cause presentation of a response interface via a user interface frontend, wherein the response interface comprises: the response to the user query; and an interactive visualization presenting one or more subject-predicate-object relationships associated with the plurality of triplets.

Clause 9. The system of any preceding or subsequent clause, wherein the interactive visualization provides a dynamic viewport for presenting the one or more subject-predicate-object relationships.

Clause 10. The system of any preceding or subsequent clause, wherein the interactive visualization presents each subject and each object of the one or more subject-predicate-object relationships as nodes, and wherein the interactive visualization presents each predicate of the one or more subject-predicate-object relationships as edges between nodes.

Clause 11. The system of any preceding or subsequent clause, wherein the interactive visualization is configured to: receive user input directed to a node of the nodes representing a subject or an object; and after receiving user input directed to the node, modify the interactive visualization to present one or more additional relationships associated with the subject or the object represented by the node.

Clause 12. The system of any preceding or subsequent clause, wherein processing the user query to determine the plurality of triplets comprises: generating a query embedding in an embedding space based on the user query; and determining a subset of triplet embeddings from a set of triplet embeddings, wherein the subset of triplet embeddings is determined based on similarity measurement between the query embedding and triplet embeddings of the set of triplet embeddings in the embedding space, wherein each of the plurality of triplets is associated with a respective triplet embedding of the subset of triplet embeddings via a vector index.

Clause 13. The system of any preceding or subsequent clause, wherein the response to the user query is generated by processing the plurality of triplets and the respective sets of text from the document corpus as additional inputs to the language model.

Clause 14. A system, comprising: one or more processors; and one or more computer-readable recording media that store instructions that are executable by the one or more processors such that the system is configurable to: process a document corpus to generate a plurality of relational unit sets, wherein each relational unit set of the plurality of relational unit sets is based on a respective set of text from the document corpus; process the plurality of relational unit sets to generate a set of relational unit set embeddings, wherein the set of relational unit set embeddings comprises a respective relational unit set embedding for each relational unit set of the plurality of relational unit sets; and construct a vector index comprising a plurality of vectors, wherein each vector of the plurality of vectors includes elements comprising: a respective relational unit set from the plurality of relational unit sets; an indication of the respective set of text from the document corpus on which the respective relational unit set is based; and the relational unit set embedding generated by processing the respective relational unit set.

Clause 15. The system of any preceding or subsequent clause, wherein each relational unit set of the plurality of relational unit sets comprises a triplet indicating subject-predicate-object relationships.

Clause 16. The system of any preceding or subsequent clause, wherein processing the document corpus to generate the plurality of relational unit sets comprises: applying a partitioning function to the document corpus to partition the document corpus into text fragments; and generate the plurality of relational unit sets based on the text fragments.

Clause 17. The system of any preceding or subsequent clause, wherein processing the plurality of relational unit sets to generate the set of relational unit set embeddings comprises: for each relational unit set of the plurality of relational unit sets, generate a combined representation of elements of the relational unit set; and process the combined representation to generate a relational unit set embedding for the set of relational unit set embeddings.

Clause 18. The system of any preceding or subsequent clause, wherein the combined representation comprises a concatenation of the elements of the relational unit set.

Clause 19. The system of any preceding or subsequent clause, wherein the indication of the respective set of text from the document corpus on which the respective relational unit set is based is determined via a linking function that associates the respective relational unit set to the respective set of text.

Clause 20. The system of any preceding or subsequent clause, wherein the set of relational unit set embeddings is generated via an embedding model trained on textual data extracted from a training document corpus.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “computer-readable recording media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that at least some aspects of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, at least some of the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is currently claimed is:

1. A system, comprising:
one or more processors; and
one or more computer-readable recording media that store instructions that are executable by the one or more processors such that the system is configurable to:
access a user query;
process the user query to generate a query embedding in an embedding space;
determine a subset of relational unit set embeddings from a set of relational unit set embeddings, wherein the subset of relational unit set embeddings is determined based on similarity measurement between the query embedding and relational unit set embeddings of the set of relational unit set embeddings in the embedding space, wherein each relational unit set embedding of the set of relational unit set embeddings is associated, via a vector index, with (i) a respective relational unit set processed to generate the relational unit set embedding and (ii) an indication of a respective set of text from a document corpus on which the respective relational unit set is based; and
generate a response to the user query by processing (i) the user query, (ii) the respective relational unit set associated with each relational unit set embedding of the subset of relational unit set embeddings, and (iii) the respective set of text associated with each relational unit set embedding of the subset of relational unit set embeddings as inputs to a language model.

2. The system of claim 1, wherein each respective relational unit set comprises a triplet indicating subject-predicate-object relationships.

3. The system of claim 1, wherein each relational unit set embedding is generated by processing a combined representation of elements of its respective relational unit set.

4. The system of claim 3, wherein the combined representation comprises a concatenation of the elements.

5. The system of claim 1, wherein the indication of the respective set of text from the document corpus on which the respective relational unit set is based is determined via a linking function that associates the respective relational unit set to the respective set of text.

6. The system of claim 1, wherein the query embedding is generated via an embedding model trained on textual data extracted from a training document corpus.

7. The system of claim 1, wherein the instructions are executable by the one or more processors such that the system is configurable to:
cause presentation the response to the user query via a user interface frontend.

8. A system, comprising:
one or more processors; and
one or more computer-readable recording media that store instructions that are executable by the one or more processors such that the system is configurable to:
access a user query;
process the user query to determine a plurality of triplets indicating subject-predicate-object relationships, wherein each triplet of the plurality of triplets is generated based on a respective set of text from a document corpus;
generate a response to the user query by at least by processing the user query as an input to a language model; and
cause presentation of a response interface via a user interface frontend, wherein the response interface comprises:
the response to the user query; and
an interactive visualization presenting one or more subject-predicate-object relationships associated with the plurality of triplets.

9. The system of claim 8, wherein the interactive visualization provides a dynamic viewport for presenting the one or more subject-predicate-object relationships.

10. The system of claim 8, wherein the interactive visualization presents each subject and each object of the one or more subject-predicate-object relationships as nodes, and wherein the interactive visualization presents each predicate of the one or more subject-predicate-object relationships as edges between nodes.

11. The system of claim 10, wherein the interactive visualization is configured to:
receive user input directed to a node of the nodes representing a subject or an object; and
after receiving user input directed to the node, modify the interactive visualization to present one or more additional relationships associated with the subject or the object represented by the node.

12. The system of claim 8, wherein processing the user query to determine the plurality of triplets comprises:
generating a query embedding in an embedding space based on the user query; and
determining a subset of triplet embeddings from a set of triplet embeddings, wherein the subset of triplet embeddings is determined based on similarity measurement between the query embedding and triplet embeddings of the set of triplet embeddings in the embedding space, wherein each of the plurality of triplets is associated with a respective triplet embedding of the subset of triplet embeddings via a vector index.

13. The system of claim 12, wherein the response to the user query is generated by processing the plurality of triplets and the respective sets of text from the document corpus as additional inputs to the language model.

14. A system, comprising:
one or more processors; and
one or more computer-readable recording media that store instructions that are executable by the one or more processors such that the system is configurable to:
process a document corpus to generate a plurality of relational unit sets, wherein each relational unit set of the plurality of relational unit sets is based on a respective set of text from the document corpus;
process the plurality of relational unit sets to generate a set of relational unit set embeddings, wherein the set of relational unit set embeddings comprises a respective relational unit set embedding for each relational unit set of the plurality of relational unit sets; and
construct a vector index comprising a plurality of vectors, wherein each vector of the plurality of vectors includes elements comprising:
a respective relational unit set from the plurality of relational unit sets;
an indication of the respective set of text from the document corpus on which the respective relational unit set is based; and
the relational unit set embedding generated by processing the respective relational unit set.

15. The system of claim 14, wherein each relational unit set of the plurality of relational unit sets comprises a triplet indicating subject-predicate-object relationships.

16. The system of claim 14, wherein processing the document corpus to generate the plurality of relational unit sets comprises:
applying a partitioning function to the document corpus to partition the document corpus into text fragments; and
generate the plurality of relational unit sets based on the text fragments.

17. The system of claim 14, wherein processing the plurality of relational unit sets to generate the set of relational unit set embeddings comprises:
for each relational unit set of the plurality of relational unit sets, generate a combined representation of elements of the relational unit set; and
process the combined representation to generate a relational unit set embedding for the set of relational unit set embeddings.

18. The system of claim 17, wherein the combined representation comprises a concatenation of the elements of the relational unit set.

19. The system of claim 14, wherein the indication of the respective set of text from the document corpus on which the respective relational unit set is based is determined via a linking function that associates the respective relational unit set to the respective set of text.

20. The system of claim 14, wherein the set of relational unit set embeddings is generated via an embedding model trained on textual data extracted from a training document corpus.
